(19) United States
(12) Patent Application Publication
(10) Pub. No.: US 2026/0257240 A1
(43) Pub. Date: Sep. 3, 2026

(54) Corner Paint Roller

(71) Applicant: Rami Badaan, Yonkers, NY (US)

(72) Inventor: Rami Badaan, Yonkers, NY (US)

(21) Appl. No.: 19/068,108

(22) Filed: Mar. 3, 2025

(51) Int. Cl. B05C 17/02

(52) U.S. Cl. CPC B05C 17/0212; B05C 17/0205

(57) ABSTRACT

A corner paint roller having a paint head component rotatably mounted onto an elongated shaft, the paint head component having a pointed midsection circumference which extends outwardly at a 45⁰ angle from the central channel of the paint head component. This configuration of the pointed midsection circumference is ideal for painting corners formed by two walls or formed between a wall and a ceiling.

### FIELD OF INVENTION

The present invention relates to paint rollers and more particularly paint rollers designed to quickly and efficiently paint corners between two adjoining walls or between the top of a wall and a ceiling.

### BACKGROUND OF THE INVENTION

Traditionally, paint is applied to a wall or ceiling by use of a paint roller having a certain width. The paint roller is dipped into paint and then rolled across a flat surface, such as a wall or ceiling to evenly distribute the paint, typically using a back-and-forth motion with slight overlap to achieve a smooth, consistent finish. Such paint rollers are ideal for covering large area. However, they are inadequate for painting the corners where two walls meet or painting between the top edge of a wall and a ceiling. For corner painting, the painter either uses a brush, which is an ineffective use of time or a specially designed device, usually having a flat surface and wheels, which are purported to facilitate painting corners.

### PRIOR ART

There have been many attempts in the prior art to provide a device to facilitate applying a coating of paint to corners where two walls meet or between to the top edge of a wall and a ceiling. U.S. Patent 9,237,799 B1 to Manning, Jr. simply uses an adjustable pole having a paint brush attached to the pivoting end of the pole. While the use of the pole eliminates the need for a ladder, it does not facilitate painting a clean corner line. Similarly, U.S. Patent 5,495,635 to Williams relates to a paint trimming device is disclosed in the form of a flat pad with a handle and wheels which guide the flat pad along the surface. However, quite often, this type of device does not completely apply paint to corner surfaces. And, due to the common pressure of applying the paint coating, some of the paint drips onto the side surface which requires the user to stop and clean the side of the device. Similarly, U.S. Patent 6,554,902 B2 to Yan, relates to a painting device having guide wheels.

Other devices have been developed to assist corner painting. In U.S. Patent 4,872,236 to Thompson, a corner painting attachment is shown having a generally circular shape composed of an open-cell foam material which is configured to fit on the handle of a paint roller adjacent to the paint applying roller and has upwardly and inwardly tapering upper surfaces that meet at a common point. And, U.S. Design Patent Des. 403,866 to Lapre shows an ornamental design for a corner paint roller which tapers outward from the handle.

Despite the attempts of the prior art, a need still exists for a corner paint roller which is simple in design, easy to use, and efficiently applies paint to corners. Such a paint roller should comprise a handle component having a top end which extends outwardly to receive the corner paint roller head. Rather than being circular, the corner paint roller head should extend outwardly from both ends at a 45⁰ angle to create a pointed midsection.

### SUMMARY OF THE INVENTION

The invention of the present subject matter relates to corner paint roller having paint head component configured with a pointed midsection circumference which extends outwardly from a central channel at a 45⁰ angle, the pointed midsection circumference being ideally suited for painting the corner formed between two walls or between a wall and a ceiling.

Accordingly, it is an object of the present subject matter to provide a corner paint roller having a paint head component configured with a pointed midsection circumference.

It is another object of the present subject matter to provide a corner paint roller having a handle, a shaft secured to the handle and terminating into a L-shaped upper end upon which the paint head component can be rotatably mounted.

It is still another object of the present subject matter to provide a corner paint roller having a paint head component with a central channel which is rotatably mounted onto the upper L-shaped end of a paint roller shaft.

It is a yet another object of the present subject matter to provide a corner paint head roller having a paint head component wherein each end of the central channel extends outwardly at a 45⁰ angle to create a pointed midsection circumference.

It is a further object of the present subject matter to provide a corner paint head roller which facilitates applying paint to a corner between two walls or between a wall and a ceiling.

It is yet a further object of the present subject matter to provide a corner paint head roller which is easy to use.

These and other objects of the present subject matter are accomplished by providing a corner paint roller comprising a shaft member having a proximal end secured to a handle, an L-shaped distal end, and a paint head component having a central channel which is rotatably mounted on the L-shaped distal end of the shaft member, the paint head component having a pointed midsection circumference which is disposed outwardly from the central channel at a 45⁰ angle.

### BRIEF DESCRIPTION OF DRAWINGS

FIG. 1 is a side perspective view of the corner paint roller of the present subject matter illustrating the paint roller head rotatbly mounted onto the paint roller handle.

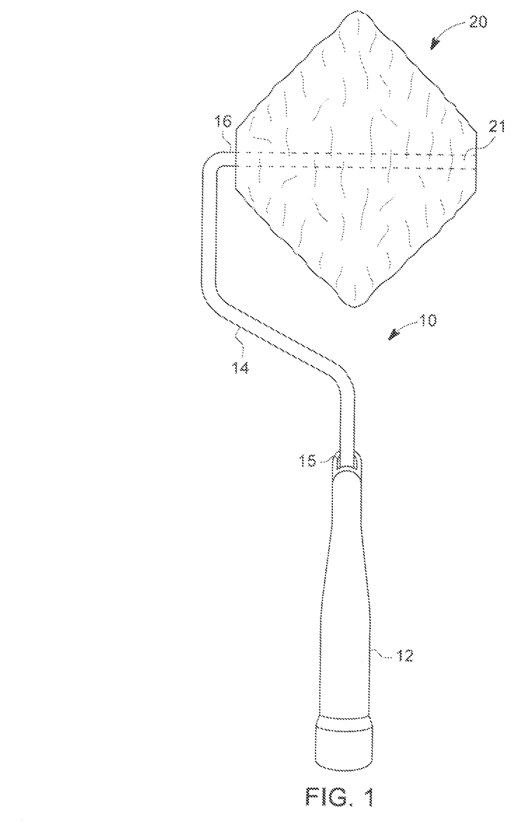

FIG. 2 is a side perspective view of the paint head component of the corner paint roller of the present subject matter.

FIG. 3 is a side perspective view showing the paint head component mounted onto the L-shaped distal end of the corner paint roller of the present subject matter wherein the handle has internal threading for attachment to an extension pole.

### DETAILED DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

Also, it is to be understood that the phraseology and terminology used herein is for the purpose of description and should not be regarded as limiting. The use of the terms "including", "comprising", "having", and variations thereof herein is meant to encompass the items listed thereafter and equivalents thereof as well as additional items.

The present subject matter is directed a corner paint roller having a central portion which is angled outwardly at about 45⁰ from a central mounting channel. This configuration creates a midsection which is pointed and ideal for applying paint to a corner between two walls or between a wall and a ceiling. The corner paint roller also includes a handle which has an L-shaped end for receiving the central channel of the paint head component.

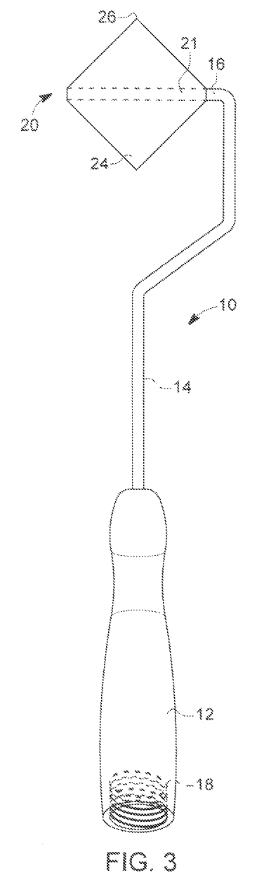

Referring to the Figures, a corner paint roller 10 is shown comprising a handle 12 is secured to an elongated shaft 14 having a proximal end 15 to which the handle 12 is secured and an L-shaped distal end 16, and a paint head component 20 having a central channel 21 configured to be rotatably mounted onto L-shaped distal end 16. Channel 21 has a first end 22 and a second end 23. The paint head component extends outwardly from the first end 22 at a 45⁰ angle and extends outwardly from the second end 23 at a 45⁰ degree angle resulting in a midsection 24 of the paint head component being formed with a pointed outer circumference 26. The configuration of the pointed midsection circumference 26 is ideal for painting corners. In one embodiment, as depicted in FIG. 3, the handle 12 is provided with internal threading 18 such that it can be removably attached to an extension pole.

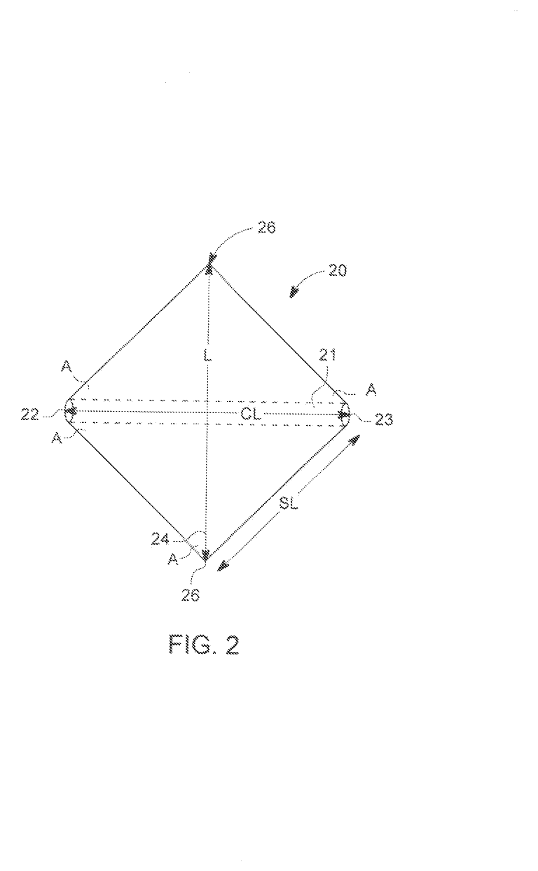

Referring to FIG. 2, the specific configuration of the head roller component 20 makes the corner paint roller of the present subject matter ideally adapted for painting corners. The length CL of the central channel 21 is from about two-and one-half inches (2.5”) to about three- and one-half inches (3.5”) and preferably about three-an-one-quarter inches (3.25”), the length L of the midsection 24 perpendicular to the length CL is from about three-and-one-quarter inches (3.25”) to about four-and-one-quarter inches (4.25”) and preferably about three-and three-quarter inches (3.75”). With these dimensions, the outwardly extending side lengths SL from the first end 22 and second end 23 to the pointed outer circumference 26 is from about two inches (2”) to about two- and one-half inches (2.5”) and preferably about two-and-one-quarter inches (2.25”). With this configuration, each of the corner angles A are 45⁰. Thus, in the preferred embodiment, the length CL is 3.25”, the length L is 3.75”, the side lengths are 2.25” and each angle A is 45⁰.

The paint head component 20 is formed from any open-cell foam material capable of retaining paint and applying paint to a surface, such materials being very well known to those skilled in the art.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, under the provisions of 35 U.S.C §112, sixth paragraph, unless the element is expressly recited using the phrase “means for. . .” and no method or process step herein is to be construed under those provisions unless the step, or steps, are expressly recited using the phrase "step(s) for. . ..”

1. A corner paint roller comprising an elongated shaft having a proximal end and an L-shaped distal end, a handle secured to said proximal end of said elongated shaft, a paint head component having a central channel rotatably mounted to said L-shaped distal end, wherein said paint head component has a midsection which is perpendicular to said central channel and disposed at 45⁰ corner angles from outwardly extending sides from said central channel to form a pointed outer circumference.

2. The corner paint roller in accordance with claim 1, wherein said paint head component is composed of an open-cell foam material.

3. The corner paint roller in accordance with claim 1, wherein said central channel of said paint head component has a length of from about rom about two-and one-half inches (2.5”) to about three-and one-half inches (3.5”).

4. The corner paint roller in accordance with claim 3, wherein said central channel of said paint head component has a length of about three-and-one-quarter inches (3.25”).

5. The corner paint roller in accordance with claim 1, wherein the length of said midsection is from about three-and-one-quarter inches (3.25”) to about four and a quarter inch (4.25”).

6. The corner paint roller in accordance with claim 5, wherein the length of said midsection is about three-and-three-quarter inches (3.75”).

7. The corner paint roller in accordance with claim 1, wherein the length of each of said outwardly extending sides from the first end 22 and second end 23 to the midsection 24 is from about two inches (2”) to about two-and one-half inches (2.5”).

8. The corner paint roller in accordance with claim 1, wherein the length of each of said outwardly extending sides is about two-and-one-quarter inches (2.25”).

9. The corner paint roller in accordance with claim 1, wherein said the length of said central channel is about three-and one-half inches (3.5”), the length of said midsection is about three-and-three-quarter inches (3.75”), and the length of each of said outwardly extending sides is about two-and-one-quarter inches (2.25”).

10. The corner paint roller in accordance with claim 1, wherein said handle is provided with internal threading.

11. The corner paint roller in accordance with claim 9, wherein said handle is provided with internal threading.
